(19) United States
(12) Patent Application Publication
(10) Pub. No.: US 2025/0289171 A1
(43) Pub. Date: Sep. 18, 2025

(54) CLOSURE NOZZLE FOR A FORMING MACHINE

(71) Applicant: ENGEL AUSTRIA GmbH, Schwertberg (AT)

(72) Inventors: Guenther KLAMMER, Aschbach Markt (AT); Raphael FISCHER, Perg (AT); Richard HARTLAUER, Ernsthofen (AT); Michael SCHMID, St. Valentin (AT); Johannes SCHEUCHENSTUHL, Ried in der Riedmark (AT); Andress BLUTMAGER, Zagersdorf (AT)

(21) Appl. No.: 19/075,073

(22) Filed: Mar. 10, 2025

(30) Foreign Application Priority Data
Mar. 13, 2024 (AT) A 50214/2024

(51) Int. Cl. B29C 45/23; F16K 5/04

(52) U.S. Cl. CPC B29C 45/23; F16K 5/04

(57) ABSTRACT

Shut-off nozzle for a molding machine, comprising a valve housing having at least one fluid channel, wherein the at least one fluid channel is designed to guide a—preferably liquid and/or plastic—fluid and a valve element which is rotationally mounted about an axis of rotation relative to the valve housing, which valve element has at least one through-opening for the passage of the fluid and is designed to vary a flow cross-section between the at least one fluid channel and the at least one through-opening by carrying out a rotational movement and thus to influence a flow of the fluid, wherein the at least one through-opening has a cross-section in a plane orthogonal to its longitudinal extension through the valve element which has a larger dimension along the axis of rotation of the valve element than perpendicular thereto.

The present invention relates to a shut-off nozzle for a molding machine having the features of the preamble of claim 1, as well as to a molding machine with such a shut-off nozzle.

Molding machines can include injection molding machines, injection presses, presses and the like. Molding machines in which a plasticized mass is fed into an open mold are also quite conceivable.

In the following, the prior art shall be outlined in the case of an injection molding machine. This analogously applies generally to molding machines.

Generic shut-off nozzles for injection molding machines comprise:
a valve housing having at least one fluid channel, wherein the at least one fluid channel is designed to guide a—preferably liquid and/or plastic—fluid and
a valve element which is rotationally mounted about a axis of rotation relative to the valve housing, which valve element has at least one through-opening for the passage of the fluid and is designed to vary a flow cross-section between the at least one fluid channel and the at least one through-opening by carrying out a rotational movement and thus to influence a flow of the fluid.

A corresponding embodiment of the prior art is disclosed, for example, in CA 2 687 054 A1.

Corresponding shut-off nozzles are used, for example, in injection molding machines to close a plasticizing and/or injection unit in order to prevent unintentional leakage of plasticized plastic material.

When an injection movement or an injection process of the plasticized plastic is to be carried out, the shut-off nozzle is opened, thus clearing the way from the plasticizing and/or injection unit into a mold cavity of a molding tool.

Since, depending on the mold cavity and the size of the mold cavity, it is necessary to convey a certain mass of plasticized plastic through the shut-off nozzle in a certain time, the size of the fluid channel is decisive for the design of the shut-off nozzle, according to which the selection and design of the shut-off nozzle is based on the size of the flow cross-section of the fluid channel.

This fluid channel is—as is known from the prior art—formed with a circular cross-section which extends in a straight line through the entire shut-off nozzle (through the valve element in an open position of the shut-off nozzle).

It can therefore be seen that the limiting component is the valve element itself. This valve element is designed to be rotationally symmetrical and can be considered as a bolt.

The through-opening for guiding the plasticized plastic is therefore the basis for the size of this valve element, since the through-opening weakens the valve element and the valve element must be designed with a size such that a perfect operation of the shut-off nozzle can still be guaranteed.

The disadvantage, however, is that not only the installation space cannot be reduced due to the required size of the valve element, but also that a certain leakage is possible due to the size of the shut-off nozzle and thus of the individual components.

The valve element thus has a certain amount of play relative to the valve housing in order to enable the valve element to rotate smoothly. The larger the valve element, the greater the play.

However, this gap leads to the need for sealing so that leakage of fluid flowing through the shut-off nozzle can be prevented or kept to a minimum, wherein in turn the sealing systems represent a weak point of the shut-off nozzle, as they are subject to wear and tear during operation and reach their limits when the shut-off nozzles become too large and the gaps therefore increase.

The object of the present invention is therefore to provide a shut-off nozzle which is at least partially improved compared to the prior art, with which the previously described disadvantages of the prior art can be at least partially improved and/or which takes up less installation space and/or which enables better sealing behavior and/or faster closing and opening times.

This object is achieved according to the invention by a shut-off nozzle for a molding machine having the features of claim 1, as well as a molding machine and/or an injection unit with such a shut-off nozzle having the features of claim 18.

According to the invention it is provided that a shut-off nozzle for a molding machine comprises:
a valve housing having at least one fluid channel, wherein the at least one fluid channel is designed to guide a—preferably liquid and/or plastic—fluid and
a valve element which is rotationally mounted about a axis of rotation relative to the valve housing, which valve element has at least one through-opening for the passage of the fluid and is designed to vary a flow cross-section between the at least one fluid channel and the at least one through-opening by carrying out a rotational movement and thus to influence a flow of the fluid,
wherein the at least one through-opening has a cross-section in a plane orthogonal to its longitudinal extension through the valve element which has a larger dimension along the axis of rotation of the valve element than perpendicular thereto.

By providing the through-opening with a sort of flat cross-section in a plane orthogonal to its longitudinal extension, it is possible to provide significantly larger areas of the cross-sectional area (i.e. flow cross-sections) while still keeping the dimensions of the valve element itself small, since this flat design of the through-opening has significantly less impact on the cross-section of the valve element—and thus on its stability.

This means that the valve element itself can be made smaller while still maintaining sufficient dimensional stability and strength for the smooth operation of the shut-off nozzle.

This possibility of reducing the size of the valve element also allows the valve housing and the entire shut-off nozzle to be made smaller, which on the one hand reduces the required installation space and on the other hand also allows the gap dimensions between the moving components to be made smaller, so that a seal between the components is made easier and safer, which can withstand for longer service lives even when wear occurs.

A further advantage of the present invention is that a rotational movement of the valve element about the axis of rotation leads to an earlier closure in a closed position of the fluid channel, since the through-opening in the direction of rotation presents a corresponding flat cross-section, which closes earlier (with a shorter rotational path).

Thus, by means of an embodiment variant according to the invention, the shut-off nozzle can be moved from an open position to a closed position (and vice versa) along a shorter rotational path of the valve element. This significantly shortens the closing and opening times and also allows the shut-off nozzle to be operated with smaller actuators.

According to the invention, the fact that a flow of the fluid can be influenced by influencing the cross-sectional area of the fluid channel can be understood to mean that the fluid channel can also be essentially completely closed so that essentially no flow of the fluid is possible. This can also be understood as the closed position of the shut-off nozzle.

In certain embodiments, it may alternatively or additionally be provided that intermediate opening degrees can be realized, for example in order to control or regulate the volume flow through the shut-off nozzle.

The shut-off nozzle is preferably designed to guide a plastic or liquid fluid. Optionally, the fluid can have a gas component, for example in foam injection molding.

Molding machines can include injection molding machines, extruders, injection presses, presses and the like. Molding machines in which the plasticized mass is fed into an open mold are also quite conceivable.

An embodiment of a shut-off nozzle according to the invention can also be used in existing systems of the prior art (as described, for example, in the introduction) and can be retrofitted, for example.

Advantageous embodiments are defined by means of the dependent claims.

It can be provided that the at least one through-opening is designed as an elongated hole in cross section in the plane orthogonal to the longitudinal extension of the at least one through-opening.

It can be provided that the at least one through-opening is square in cross-section in the plane orthogonal to the longitudinal extension of the at least one through-opening, preferably with a rectangular cross-section, particularly preferably with rounded corners. A design of the through-opening with a square cross-section (in particular with rounded corners) can lead to particularly advantageous resulting forces which arise from a fluid guided through under pressure.

Preferably, it can be provided that the dimension of the at least one through-opening in the cross section in the plane orthogonal to the longitudinal extension of the at least one through-opening along the axis of rotation to a height dimension perpendicular thereto is at least in a ratio of 1.5:1.0—particularly preferably in a ratio of 2.0:1.0.

It can be provided that the dimension of the at least one through-opening along the axis of rotation in cross section in the plane orthogonal to the longitudinal extent of the at least one through-opening with its size is in a range of plus/minus 20%, preferably plus/minus 10%, particularly preferably plus/minus 5%, of a diameter of the valve element in the region of the at least one through-opening. Preferably, it can be provided that the dimension of the at least one through-opening along the axis of rotation in the cross section in the plane orthogonal to the longitudinal extent of the at least one through-opening is equal to the diameter of the valve element in the region of the at least one through-opening.

Preferably, it can be provided that the valve element is designed as a bolt.

It can be provided that the valve element has exactly one through-opening.

It can be provided that the at least one fluid channel of the valve housing is penetrated in a flow direction of the fluid by a recess, which recess receives the valve element.

Preferably, it can be provided that this recess, which receives the valve element, is designed as a bore.

It can be provided that the at least one fluid channel of the valve housing in the flow direction of the fluid
at an inlet point of the at least one fluid channel into the at least one through-opening of the valve element and/or
at an outlet point of the at least one through-opening of the valve element into the at least one fluid channel
has the same cross-sectional shape as the at least one through-opening, so that along the flow direction of the fluid there are no steps, edges, corners or cross-sectional jumps for the fluid in an open position of the shut-off nozzle.

Preferably, it can be provided that the cross-sectional area for the fluid through the fluid channel and the through-opening of the shut-off nozzle is constant in an open position of the shut-off nozzle, in particular so that no pressure variations or flow velocity changes of the fluid occur along the flow path through the shut-off nozzle due to cross-sectional changes.

Preferably, it can be provided that the at least one fluid channel transitions, preferably continuously, into a circular cross-section along its longitudinal extent before the inlet point into the at least one through-opening and/or after the outlet point from the at least one through-opening. In particular, it can be provided that the transition before the inlet point into the at least one through-opening and/or after the outlet point is conical, preferably wherein a transition before the inlet point into the at least one through-opening and a transition after the outlet point are mirrored and/or implemented by the same cone.

Since the fluid channel before and after the valve element in turn changes into a circular cross-section, it can advantageously be provided that, despite the presence of an exemplary embodiment according to the invention, the advantages of a circular connection point of the shut-off nozzle on a molding tool and/or a plasticizing and/or injection unit of a molding machine are still utilized.

It can be provided that the at least one fluid channel and/or the at least one through-opening have one and preferably the same size of a cross-sectional area along its/their longitudinal extent, so that there are no variations in the pressure and/or the flow velocity of the fluid due to cross-sectional changes along the flow direction of the fluid through the shut-off nozzle in an open position of the valve element.

In other words, it can be provided that the fluid channel and the through-opening are aligned at their transitions in an open position of the shut-off nozzle.

Preferably, it can be provided that the valve element is mounted in the valve housing in a floating manner along the axis of rotation.

It can be provided that the valve element is arranged in the valve housing in a recess, preferably a bore, passing through the valve housing.

Preferably, it can be provided that the valve element is preloaded relative to the valve housing by means of at least one spring element, in particular preferably at least one disc spring.

It can be provided that the valve element is preloaded at both ends of the recess passing through the valve housing by means of at least one spring element, preferably a disc spring.

It can be provided that the valve element is sealed against the valve housing by means of at least one sealing element, preferably at least one sealing ring.

Preferably, it can be provided that the valve element is rotationally connected to an actuating element in s motion-locked manner, which actuating element is designed to rotate the valve element via a rotational movement between a closed position and an open position.

It can be provided that the actuating element is designed as a fork element which is connected on both sides in a rotationally motion-locked manner to the valve element passing through the valve housing.

It can be provided that the valve element is mounted relative to the valve housing and/or relative to a bearing element of the valve housing along the axis of rotation with a play of 0.01 mm to 5 mm—preferably 0.03 mm to 2.5 mm, particularly preferably 0.05 mm to 1 mm.

Furthermore, protection is sought for a molding machine and/or an injection unit for a molding machine with a shut-off nozzle according to the invention.

Preferably, it can be provided that the injection unit has an injection screw arranged in a barrel so as to be movable rotationally about its longitudinal axis and translationally along its longitudinal axis.

This injection screw can be designed to plasticize a material to be plasticized by a rotational movement about the longitudinal axis and to expel the plasticized material (or the plasticized fluid) from the barrel by a longitudinal movement along the longitudinal axis, preferably via a shut-off nozzle according to the invention adjoining the barrel.

Further advantages and details of the invention are apparent from the figures and the associated description of the figures. In particular

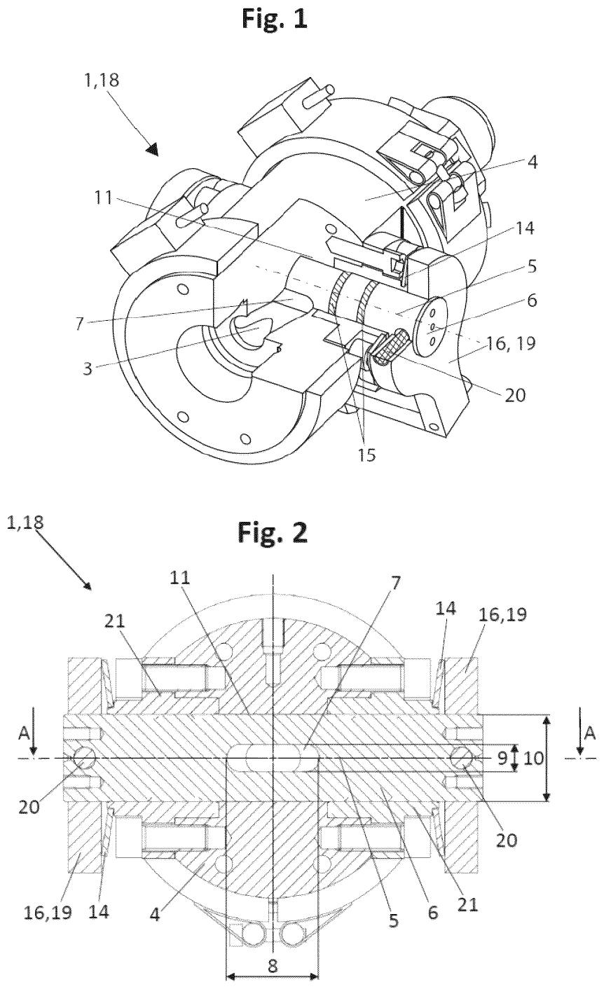

FIG. 1 is a perspective view of an inventive exemplary embodiment of a shut-off nozzle,

FIG. 2 is a section through the exemplary embodiment of FIG. 1 in a plane orthogonal to the longitudinal extension of the through-opening,

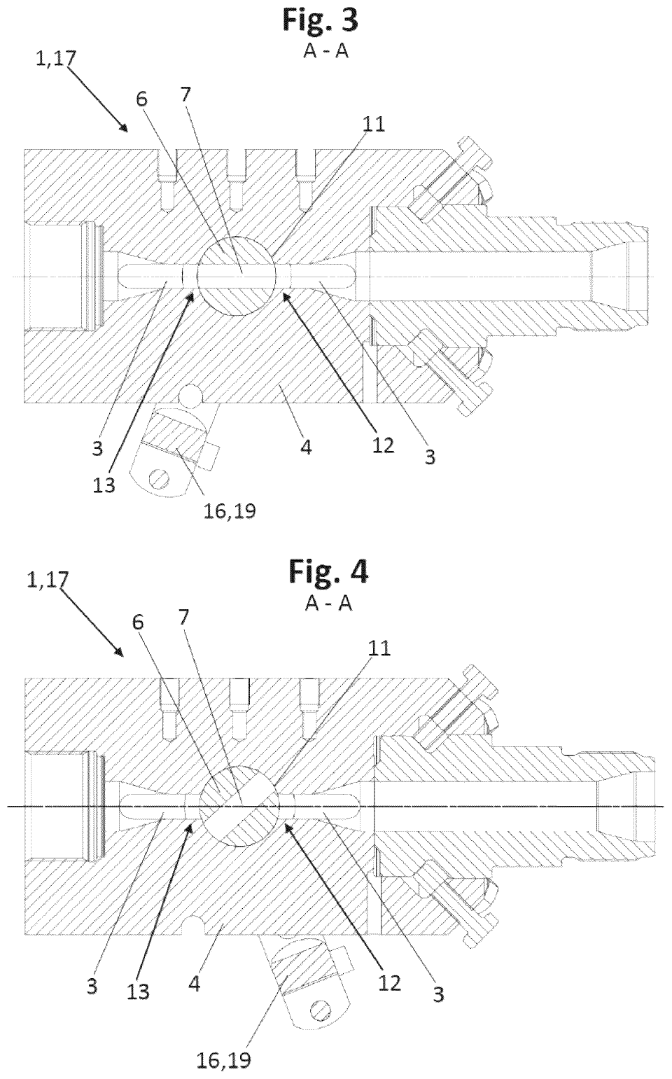

FIG. 3 is the section shown in FIG. 2 in an open position of the valve element,

FIG. 4 is the section shown in FIG. 2 in a closed position of the shut-off nozzle,

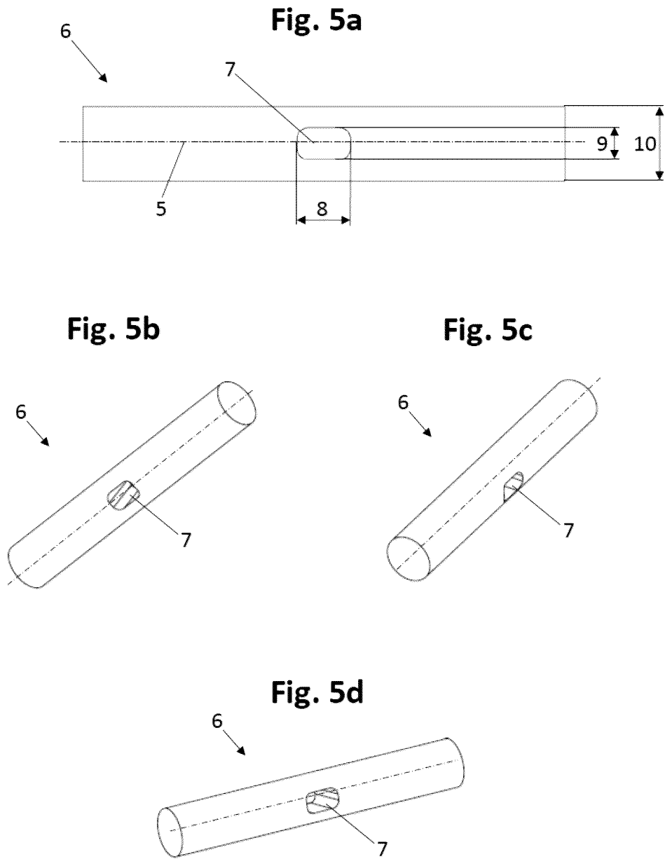

FIGS. 5a-d show an alternative embodiment of a valve element in different views, and

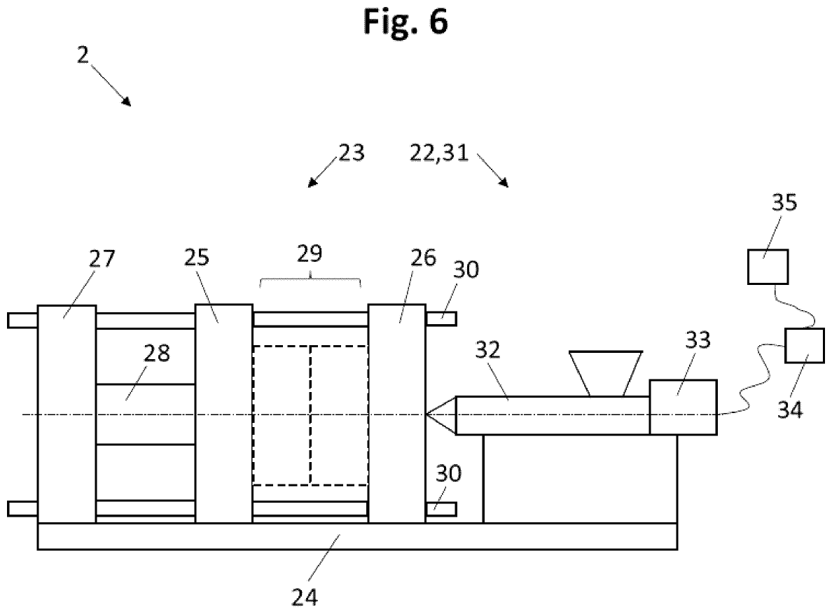

FIG. 6 shows an exemplary embodiment of a molding machine.

FIG. 1 shows a perspective view of an exemplary embodiment of a shut-off nozzle 1 according to the invention.

For better illustration, a quarter of the shut-off nozzle 1 is cut out in the perspective view of FIG. 1, so that a clear view of the internal components of the shut-off nozzle 1 is provided.

FIG. 2 shows a sectional view through the exemplary embodiment of FIG. 1 through the shut-off nozzle, wherein the sectional plane was placed orthogonal to the longitudinal extension of the through-opening 7 of the valve element 6 (in an opening position 18 of the valve element 6) and furthermore has the axis of rotation 5 of the valve element 6.

FIGS. 3 and 4 show sectional views of the same exemplary embodiment of the shut-off nozzle 1, wherein the sectional plane A-A of FIGS. 3 and 4 is marked in FIG. 2.

FIGS. 3 and 4 differ in that FIG. 3 shows an open position 18 of the shut-off nozzle 1 and FIG. 4 shows a closed position 17 of the shut-off nozzle 1.

From FIGS. 1 to 4 it can be seen that the shut-off nozzle 1 comprises a valve housing 4.

The valve housing 4 of this embodiment is formed by a central part of the valve housing 4 and the screwed-on bearing elements 21.

A central fluid channel 3 leads through the valve housing 4 and is designed to guide a fluid, preferably a liquid and/or plastic fluid.

Furthermore, the valve housing 4 comprises a recess 11 which penetrates the valve housing 4 and also penetrates the fluid channel 3.

In this exemplary embodiment, this recess 11 is implemented by a bore through the valve housing 4 and the bearing elements 21.

In the recess 11, the valve element 6 is arranged and mounted in the valve housing 4 so as to rotate about the axis of rotation 5.

For example, it can be provided that a pressure is built up in a gap between recess 11 and valve element 6 via a lubricant, preferably a lubricating oil.

This pressure can preferably correspond to the pressure of the fluid guided through the through-opening 7 or be adapted to this, which results in a particularly favorable influence on the stresses in the valve element 6.

Particularly preferably, the stresses in the valve element 6 (caused by the pressure of the fluid guided through the through-opening 7) can thus be significantly reduced and the service life of the valve element 6 can thus be increased.

In this embodiment, the valve element 6 is implemented as a bolt.

The valve element 6 has a through-opening 7 which, in the open position 18 of the shut-off nozzle 1, forms an extension of the fluid channel 3 so that the fluid can pass unhindered through the fluid channel 3 and the through-opening 7 through the shut-off nozzle 1.

If a rotational movement of the valve element 6 is now carried out about the axis of rotation 5, the shut-off nozzle 1 can be transferred into a closed position 17, as shown for example in FIG. 4.

In this closed position 17, the fluid channel 3 is interrupted by the valve element 6, whereby the passage of a fluid through the shut-off nozzle 1 can be prevented.

It can be seen that by the rotational movement of the valve element 6, a flow cross-section for a fluid between the fluid channel 3 and the through-opening 7 can be changed.

The valve element 6 is floatingly mounted in the valve housing 4.

This floating mounting of the valve element 6 in the valve housing 4 is clearly visible in FIG. 2.

The valve element 6 is preloaded against the valve housing 4 via the disc springs 14.

These disc springs 14 are arranged between the valve housing 4 and the actuating elements 16 which are rotationally connected to the valve element 6.

In this exemplary embodiment of the shut-off nozzle 1, the actuating elements 16 are implemented as part of the fork element 19 and are rotationally connected to the valve element 6 via the pins 20.

By actuating the fork element 19 at a lower articulation point, a rotational movement of the valve element 6 about the axis of rotation 5 can be implemented.

Such an actuation of the fork element 19 can be carried out, for example, via a linear drive.

By actuating and thus rotating the valve element 6 about the axis of rotation 5, the valve element 6 can be rotated between an open position 18 and a closed position 17.

The valve element 6 is sealed against the valve housing 4 by means of the sealing elements 15.

The floating mount allows the valve element 6 a certain degree of free movement along the axis of rotation 5, so that the valve element 6 can align itself with the through-opening 7 relative to the fluid channel 3.

Due to this axial mobility of the valve element 6 relative to the valve housing 4, the flow of the fluid through the valve element 6 allows the valve element to be aligned in such a way that the fluid channel 3 is aligned with the through-opening 7 at an inlet point 12 of the fluid channel 3 into the through-opening 7 and at the outlet point 13 of the through-opening 7 into the fluid channel 3.

This alignment prevents edges, steps or other disruptive influences on the flow of the fluid through the shut-off nozzle 1 and implements an optimal flow without the formation of turbulent flows which may lead to excessive heating of the valve housing 4 or deposits in the fluid channel 3.

In order to reduce the size, it is provided in this exemplary embodiment that the through-opening 7 has a larger dimension 8 in a plane orthogonal to its longitudinal extension (as shown in FIG. 2) along the axis of rotation 5 than perpendicular thereto.

In other words, the through-opening 7 has a flat cross-sectional shape.

In this specific embodiment, the through-opening 7 is designed with a dimension 8 (see FIG. 2) parallel to the axis of rotation 5 greater than a height dimension 9 orthogonal thereto.

It can be seen that this design of the through-opening 7 provides the largest possible flow cross-section, which nevertheless has little influence on the stability and the cross-section of the valve element 6 (while the diameter 10 of the valve element 6 is nevertheless relatively small).

In this exemplary embodiment of FIGS. 1 to 4, the ratio of the dimension 8 to the height dimension 9 is implemented with a ratio of 2:1.

The dimension 8 of the through-opening 7 is essentially the same size as the diameter 10 of the valve element 6.

However, in order to be able to easily connect the shut-off nozzle 1 to a molding tool of the molding machine 2 and/or to an injection unit of the molding machine 2, the fluid channel 3 changes into a circular cross-section before the inlet point 12 and after the outlet point 12.

However, this transition and the circular cross-section of the shut-off nozzle 1 are designed in such a way that the cross-sectional area of the fluid channel 3 and the through-opening 7 is constant in size along their longitudinal extension through the shut-off nozzle 1, so that when the fluid flows through the shut-off nozzle 1, there is no cross-sectional narrowing or widening, which means that no pressure variations or flow velocity changes occur during the passage of the fluid through the shut-off nozzle 1.

In the specific exemplary embodiment of the shut-off nozzle 1, the through-opening 7 is implemented as an elongated hole in the valve element 6 designed as a bolt.

FIGS. 5a to 5d show an alternative embodiment of a closure element 6. This closure element 6 can be used, for example, in a shut-off nozzle 1 according to FIGS. 1 to 4 with adapted transitions.

FIG. 5a shows a view which is projected in alignment towards the through-opening 7.

It can be seen that the through-opening 7 in cross-section is formed in the plane orthogonal to the longitudinal extension of the through-opening 7 as a square or has a rectangular cross-sectional shape, wherein the corners of this square or rectangular configuration are rounded.

Such a design of the cross-sectional shape of the through-opening 7 with a square cross-section (in particular with rounded corners) results in particularly advantageous resulting forces which result from a fluid guided under pressure through the through-opening 7.

FIGS. 5b to 5d show the embodiment of FIG. 5a in different perspective views.

The molding machine 2 shown as an example in FIG. 6 is an injection molding machine and has an injection unit 22 and a closing unit 23, which are arranged together on a machine frame 24. The machine frame 24 could alternatively be constructed in several parts.

The closing unit 23 has a fixed mold clamping plate 25, a movable mold clamping plate 26 and a front plate 27.

The movable mold clamping plate 26 is movable relative to the machine frame 24 via a symbolically represented toggle lever mechanism 28.

Mold halves of a mold 29 can be clamped or mounted on the fixed mold clamping plate 25 and the movable mold clamping plate 26 (shown in dashed lines).

The fixed mold clamping plate 25, the movable mold clamping plate 26 and the front plate 27 are supported and guided relative to one another by the spars 30.

The mold 29 shown closed in FIG. 6 has at least one cavity. An injection channel leads to the cavity, via which a plasticized mass of the plasticizing unit 31 can be supplied (for example via a shut-off nozzle 1 known from the previous figures).

The injection unit 22 of this exemplary embodiment has a barrel 32 and an injection screw arranged in the barrel 32. This injection screw can be rotated about its longitudinal axis and can be moved axially along the longitudinal axis in the conveying direction.

These movements are driven by a schematically shown drive unit 33. Preferably, this drive unit 33 comprises a rotary drive for the rotary movement and a linear drive for the axial injection movement.

FIG. 5 shows a molding machine 2 with an injection unit 22, wherein the injection unit 22 shown in this exemplary embodiment has an injection screw, which is also used for plasticizing a material to be plasticized.

The plasticizing group 31 (and thus the injection unit 22) is in signal connection with a control or regulating unit 34. The control or regulating unit 34 outputs control commands, for example, to the plasticizing group 31 and/or the drive unit 33.

The control or regulating unit 34 can be connected to an operating unit and/or a display device 35 or can be an integral part of such an operating unit.

### LIST OF REFERENCE NUMERALS

1 shut-off nozzle
2 molding machine
3 fluid channel
4 valve housing
5 axis of rotation
6 valve element
7 through-opening
8 dimension
9 height dimension
10 diameter of the valve element
11 recess
12 inlet point
13 outlet point
14 disc spring
15 sealing element
16 actuating element
17 closed position
18 open position
19 fork element
20 pin
21 bearing element
22 injection unit
23 closing unit
24 machine frame
25 fixed mold clamping plate
26 movable mold clamping plate
27 front plate
28 toggle lever mechanism
29 molding tool
30 spar
31 plasticizing group
32 barrel
33 drive unit
34 control or regulating unit
35 operating unit and/or display device

1. A shut-off nozzle for a molding machine, comprising
a fluid housing having at least one fluid channel, wherein the at least one fluid channel is designed to guide a—preferably liquid and/or plastic—fluid and
a valve element which is rotationally mounted about a axis of rotation relative to the valve housing, which valve element has at least one through-opening for the passage of the fluid and is designed to vary a flow cross-section between the at least one fluid channel and the at least one through-opening by carrying out a rotational movement and thus to influence a flow of the fluid,
wherein the at least one through-opening has a cross-section in a plane orthogonal to its longitudinal extension through the valve element which has a larger dimension along the axis of rotation of the valve element than perpendicular thereto.

2. The shutoff nozzle according to claim 1, wherein the at least one through-opening is designed as an elongated hole and/or square in cross section in the plane orthogonal to the longitudinal extension of the at least one through-opening.

3. The shut-off nozzle according to claim 1, wherein the ratio of the dimension of the at least one through-opening in cross-section in the plane orthogonal to the longitudinal extension of the at least one through-opening along the axis of rotation to a height dimension perpendicular thereto is at least equal to 1.5:1, preferably 2:1.

4. The shut-off nozzle according to claim 1, wherein the value of the dimension of the at least one through-opening along the axis of rotation in cross-section in the plane orthogonal to the longitudinal extent of the at least one through-opening is in a range of plus/minus 20%, preferably plus/minus 10%, particularly preferably plus/minus 5%, of a diameter of the valve element in the region of the at least one through-opening.

5. The shut-off nozzle according to claim 1, wherein the valve element is designed as a bolt and/or has exactly one through-opening.

6. The shut-off nozzle according to claim 1, wherein the at least one fluid channel of the valve housing is penetrated in a flow direction of the fluid by a recess, which recess receives the valve element.

7. The shut-off nozzle according to claim 1, wherein the at least one fluid channel of the valve housing in the flow direction of the fluid has
at an inlet point of the at least one fluid channel into the at least one through-opening of the valve element, and/or
at an outlet point of the at least one through-opening of the valve element into the at least one fluid channel
the same cross-sectional shape as the at least one through-opening.

8. The shut-off nozzle according to claim 7, wherein the at least one fluid channel transitions, preferably continuously, into a circular cross-section along its longitudinal extent before the inlet point into the at least one through-opening and/or after the outlet point from the at least one through-opening.

9. The shut-off nozzle according to claim 1, wherein the at least one fluid channel and/or the at least one through-opening have one, preferably the same, size of a cross-sectional area along its/their longitudinal extent.

10. The shut-off nozzle according to claim 1, wherein the valve element is mounted in the valve housing in a floating manner along the axis of rotation.

11. The shut-off nozzle according to claim 1, wherein the valve element is arranged in the valve housing in a recess, preferably a bore, passing through the valve housing.

12. The shut-off nozzle according to claim 1, wherein the valve element is preloaded relative to the valve housing by means of at least one spring element, preferably at least one disc spring.

13. The shut-off nozzle according to claim 11, wherein the valve element is preloaded at both ends of the recess passing through the valve housing by means of at least one spring element, preferably at least one disc spring.

14. The shut-off nozzle according to claim 1, wherein the valve element is sealed relative to the valve housing by means of at least one sealing element, preferably at least one sealing ring.

15. The shut-off nozzle according to claim 1, wherein the valve element is rotationally connected in a motion-locked manner to an actuating element, which actuating element is designed to rotate the valve element via a rotational movement between a closed position and an open position.

16. The shut-off nozzle according to claim 11, wherein the actuating element is designed as a fork element which is connected on both sides in a rotationally motion-locked manner to the valve element passing through the valve housing.

17. The shut-off nozzle according to claim 1, wherein the valve element is mounted relative to the valve housing and/or relative to a bearing element of the valve housing along the axis of rotation with a play of 0.01 mm to 5 mm, preferably 0.03 mm to 2.5 mm, particularly preferably 0.05 mm to 1 mm.

18. A molding machine and/or injection unit for a molding machine, with a shut-off nozzle according to claim 1.
